(19) United States
(12) Patent Application Publication
(10) Pub. No.: US 2026/0214325 A1
(43) Pub. Date: Jul. 23, 2026

(54) IMAGE CONTROL APPARATUS, IMAGE CONTROL METHOD, PROGRAM, AND RECORDING MEDIUM

(71) Applicant: FUJIFILM Corporation, Tokyo (JP)

(72) Inventors: Yoshitsugu FUKUNAGA, Saitama-shi (JP); Hiroyuki TACHIBANA, Saitama-shi (JP)

(73) Assignee: FUJIFILM Corporation, Tokyo (JP)

(21) Appl. No.: 19/566,617

(22) Filed: Mar. 13, 2026

Related U.S. Application Data
(63) Continuation of application No. PCT/JP2024/025326, filed on Jul. 12, 2024.

(30) Foreign Application Priority Data
Sep. 19, 2023 (JP) 2023-150893

(51) Int. Cl. H04N 23/661; H04N 23/63

(52) U.S. Cl. CPC H04N 23/661; H04N 23/632

(57) ABSTRACT

An apparatus, a method, a program, and a recording medium capable of efficiently providing necessary image data for each user are provided. An image control apparatus 10 includes a processor 10a, in which the processor 10a is configured to acquire information related to a specific imaging period in an imaging apparatus, output a captured image group captured in the specific imaging period by the imaging apparatus to a storage device, and in a case where the specific imaging period is finished, output access information for accessing the captured image group in the storage device to a display device.

### CROSS-REFERENCE TO RELATED APPLICATIONS

This application is a Continuation of PCT International Application No. PCT/JP 2024/025326 filed on Jul. 12, 2024, which claims priority under 35 U.S.C. § 119(a) to Japanese Patent Application No. 2023-150893 filed on Sep. 19, 2023. The above applications are hereby expressly incorporated by reference, in their entirety, into the present application.

### BACKGROUND OF THE INVENTION

### 1. Field of the Invention

An embodiment of the present invention relates to an image control apparatus, an image control method, a program, and a recording medium capable of efficiently providing necessary image data for each user.

### 2. Description of the Related Art

There are various locations where imaging is performed, such as a theme park and an event venue, and various occasions for imaging. The number of captured images at one location or occasion tends to increase because of improvement in performance and the like of imaging equipment. In addition, a technology for managing image data obtained by imaging for each user (imaging person) is already known. Examples of such a technology include the technology according to JP2004-112637A.

The technology according to JP2004-112637A provides a configuration for accumulating image data captured by a digital camera and specification information for specifying its user in association with each other, and selectively permitting access to the image data corresponding to the specification information accumulated for the user specified by the specification information. Accordingly, an image storage service for storing image data and the like captured by a digital camera on behalf of a user can be implemented, and a processing service such as printing based on the stored image data can be provided.

### SUMMARY OF THE INVENTION

In a so-called selfie studio or a theme park, a service for performing imaging and selling a captured image may be usable by an unspecified number of visitors. Such a service is operated by imaging an enormous number of visitors via an imaging system installed in a specific location, and visitors are not identified during imaging.

In managing the image data obtained by imaging by applying the technology according to JP2004-112637A, it is difficult to apply the technology in a case where it is difficult to acquire identification information from the user. In addition, in a case where different user groups are continuously imaged over a series of imaging occasions, it is also difficult to separately manage and provide image data for each user group. Furthermore, the identification information of the user may be sensitive information, and management of the identification information may increase the management load on the imaging system side.

An embodiment of the present invention is conceived in view of the above circumstances, and an object thereof is to provide an apparatus, a method, a program, and a recording medium capable of efficiently providing necessary image data for each user.

The above object is achieved by an image control apparatus according to any one of [1] to [11].
[1] An image control apparatus comprising a processor, in which the processor is configured to acquire information related to a specific imaging period in an imaging apparatus, output a captured image group captured in the specific imaging period by the imaging apparatus to a storage device, and in a case where the specific imaging period is finished, output access information for accessing the captured image group in the storage device to a display device.
[2] The image control apparatus according to [1], in which each image of the captured image group is a still image.
[3] The image control apparatus according to [1] or [2], in which the information related to the specific imaging period is an imaging start instruction and an imaging finish instruction in the imaging apparatus.
[4] The image control apparatus according to [3], in which the imaging apparatus has a remote imaging function, and the processor is configured to, based on the received imaging start instruction and the received imaging finish instruction, control a start and a finish of imaging of the imaging apparatus through the remote imaging function.
[5] The image control apparatus according to any one of [1] to [4], in which the processor is configured to receive a captured image being captured by the imaging apparatus from the imaging apparatus, and output each image of the received captured image group to the display device.
[6] The image control apparatus according to [5], in which the processor is configured to receive a live view image that is the captured image being captured by the imaging apparatus, from the imaging apparatus, and display the received live view image on the display device in real time.
[7] The image control apparatus according to any one of [1] to [6], in which the processor is configured to display at least one image of the captured image group on the display device.
[8] The image control apparatus according to any one of [3] to [7], in which the processor is configured to recognize, as the imaging start instruction, the imaging finish instruction related to a captured image group that is a target for outputting an immediately previous code.
[9] The image control apparatus according to any one of [3] to [8], in which the imaging apparatus has a remote imaging function, and the processor is configured to receive the imaging start instruction and the imaging finish instruction through an operation reception apparatus for receiving the imaging start instruction and the imaging finish instruction, and based on the start instruction and the finish instruction, control a start and a finish of imaging of the imaging apparatus through the remote imaging function.
[10] The image control apparatus according to any one of [1] to [9], in which the processor is configured to generate an access code that is the access information, by encoding information related to a storage location of the captured image group in the storage device, and output display data for the access code to a transmission device that transmits the display data to a terminal of a user.
[11] The image control apparatus according to any one of [1] to [10], in which the processor is configured to generate an access code that is the access information, by encoding information related to a storage location of the captured image group in the storage device, and transmit printing data of the access code to a printing apparatus.

The above object is also achieved by an image control method according to [12].
[12] An image control method comprising a step of acquiring, via a processor, information related to a specific imaging period in an imaging apparatus, a step of outputting, via the processor, a captured image group captured in the specific imaging period by the imaging apparatus to a storage device, and a step of outputting, via the processor, in a case where the specific imaging period is finished, access information for accessing the captured image group in the storage device to a display device.

A program according to an embodiment of the present invention is a program for causing a computer to execute each step included in the image control method according to [12].

A recording medium according to an embodiment of the present invention is a computer-readable recording medium storing a program for causing a computer to execute each step included in the image control method according to [12].

According to one embodiment of the present invention, an apparatus, a method, a program, and a recording medium capable of efficiently providing necessary image data for each user are provided.

### BRIEF DESCRIPTION OF THE DRAWINGS

FIG. 1 is a diagram showing an example of a network configuration including an image control apparatus according to an embodiment of the present invention.

FIG. 2 is a diagram showing a hardware configuration example of the image control apparatus according to the embodiment of the present invention.

FIG. 3 is a diagram showing functional portions of the image control apparatus according to the embodiment of the present invention.

FIG. 4 is a diagram showing a configuration example of an imaging period information DB according to the embodiment of the present invention.

FIG. 5 is a diagram showing a configuration example of a captured image DB according to the embodiment of the present invention.

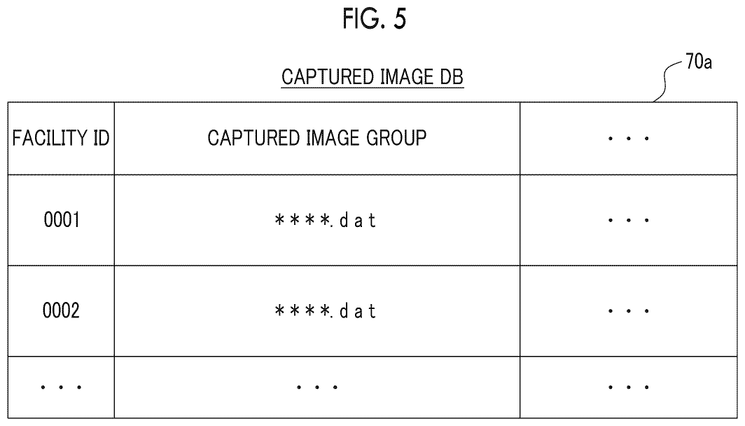

FIG. 6 is a flowchart of an image control method according to the embodiment of the present invention.

FIG. 7 is a diagram showing a display example of an access code according to the embodiment of the present invention.

FIG. 8 is a diagram showing a situation where a captured image group is viewed according to the embodiment of the present invention.

### DESCRIPTION OF THE PREFERRED EMBODIMENTS

Hereinafter, a specific embodiment of the present invention will be described.

For convenience of description, the following description may be provided in terms of a graphic user interface (GUI). In addition, basic data processing technologies (a communication/transmission technology, a data acquisition technology, a data recording technology, a data processing/analysis technology, a machine learning technology, an image processing technology, a visualization technology, and the like) for implementing the present invention are well-known technologies. Thus, descriptions related to the basic data processing technologies will not be provided.

In the present specification, a concept of a “device” includes a single device that exhibits a specific function, and also includes a combination of a plurality of devices that are present independently of each other in a distributed manner and exhibit a specific function in cooperation (coordination).

In the present specification, a “user” is a user who receives a service for imaging via an image control apparatus according to an embodiment of the present invention, and output and provision of image data obtained by the imaging. Specifically, a “user” is a person who can view and appropriately use the image data obtained by a function of the image control apparatus according to an embodiment of the present invention.

In the present specification, a “person” means an entity that performs a specific action, includes an individual, a group, a corporation such as a company, an organization, and the like, and may also include a computer and a device constituting artificial intelligence (AI). Artificial intelligence (AI) implements intellectual functions such as reasoning, prediction, and determination using hardware resources and software resources. Artificial intelligence may use any algorithm such as, for example, an expert system, case-based reasoning (CBR), a Bayesian network, or a subsumption architecture.

### Embodiment of Present Invention

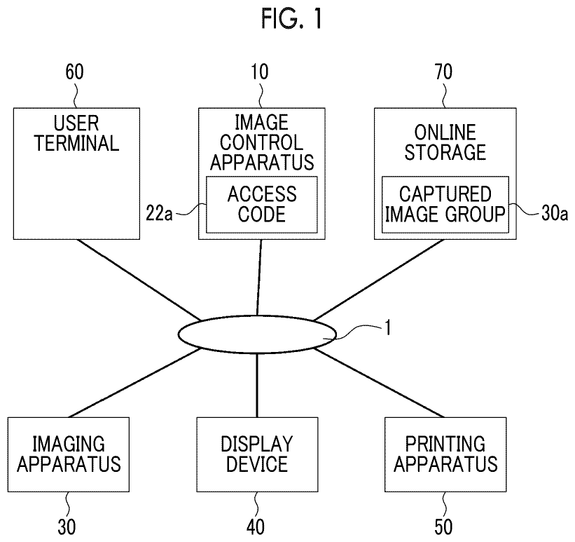

In the embodiment (hereinafter, referred to as the present embodiment) of the present invention, an image control apparatus 10 according to the embodiment of the present invention, as shown in FIG. 1, stores a captured image group 30a that is captured by an imaging apparatus 30 during a specific imaging period, in an online storage 70 on a network 1 and outputs access information (hereinafter, referred to as an access code 22a) for accessing the captured image group 30a to the user on a display device 40.

Not only a form of connection through a wired or wireless network 1 but also a form of direct connection and the like between internal bus wiring of the image control apparatus 10 and an interface of the imaging apparatus 30 can be assumed between the image control apparatus 10 and the imaging apparatus 30. Specific examples of the imaging apparatus 30 are not particularly limited, and any imaging apparatus that can perform imaging in a digital format using a semiconductor sensor as an imaging element, such as a digital still camera, a tablet terminal equipped with a camera unit, or a smartphone, can be adopted.

Meanwhile, the user accesses the captured image group 30a in the online storage 70 through the network 1 by executing a reading operation via a user terminal 60 for the access code 22a (for example, a two-dimensional barcode) output onto the display device 40. The user can view the captured image group 30a on the user terminal 60, and download data of a desired captured image or print out the captured image as necessary.

Specific examples of a service operated as described above may be assumed to include an imaging service in various attraction facilities of a theme park, a selfie studio service in a karaoke box or a dedicated imaging room, and an imaging service provided by a professional cameraman in a venue of a live event such as a concert and a music festival. In the following description, a facility that uses a service which is an application target of an image control method according to the embodiment of the present invention will be referred to as a “service facility”.

Among types of the service facility, an attraction facility includes a ride attraction such as a Ferris wheel and a roller coaster, a walk-through attraction such as a maze and a haunted house, a show attraction such as a musical, a dance, and a parade, and the like.

The application target of the present invention is not limited to the imaging service in the service facility. Any form of executing imaging via the imaging apparatus 30 during an imaging period designated by the user (for example, a period designated by the user from an imaging start timing to an imaging finish timing) and outputting the access code 22a related to the captured image group 30a obtained by imaging may be the application target of the present invention.

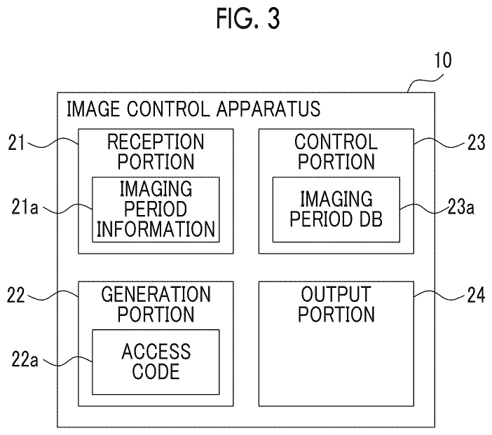

To exhibit the above functions, the image control apparatus 10 in the present embodiment includes functional portions such as a reception portion 21, a generation portion 22, a control portion 23, and an output portion 24 (see FIG. 3). Specific functions and the like of these functional portions will be described in order in the following description.

An “image” in the present invention is composed of a plurality of pixels, is represented by gradation values of each of the plurality of pixels, and includes one or more subjects. Digital image data (hereinafter, image data) that defines an image with a set resolution is generated by compressing data in which the gradation values for each pixel are recorded using a predetermined compression method. Examples of types of the image data include image data of irreversible compression such as a joint photographic experts group (JPEG) format, and image data of reversible compression such as a graphics interchange format (GIF) or a portable network graphics (PNG) format.

### Configuration Example of Image Control Apparatus

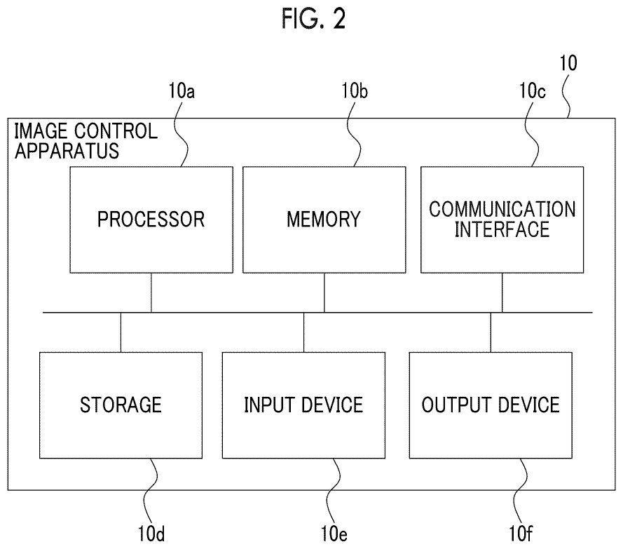

Next, a configuration example of the image control apparatus 10 according to the present embodiment will be described with reference to FIG. 2. The image control apparatus 10 is composed of a server apparatus disposed in the service facility. Alternatively, the image control apparatus 10 may be composed of an apparatus that is a computer, specifically a smartphone, a tablet terminal, or a laptop personal computer (PC), used by the user in the service facility and that has a server function such as transmission and reception related to the captured image group 30a on the network, and a series of functions such as generation and output of the access code. The image control apparatus 10 may also be composed of the imaging apparatus 30 that has a server function such as transmission and reception related to the captured image group 30a on the network, and a series of functions such as generation and output of the access code 22a.

As shown in FIG. 2, the computer constituting the image control apparatus 10 comprises a processor 10a, a memory 10b, a communication interface 10c, a storage 10d, an input device 10e, and an output device 10f.

The processor 10a is composed of, for example, a central processing unit (CPU), a micro-processing unit (MPU), a micro controller unit (MCU), a graphics processing unit (GPU), a digital signal processor (DSP), a tensor processing unit (TPU), or an application specific integrated circuit (ASIC).

The memory 10b is composed of, for example, a semiconductor memory such as a read-only memory (ROM) and a random-access memory (RAM).

The communication interface 10c may be composed of, for example, a network interface card or a communication interface board. The computer constituting the image control apparatus 10 can communicate with other apparatuses connected to a communication network such as the Internet and a mobile communication line through the communication interface 10c.

The storage 10d is composed of, for example, a flash memory, a hard disk drive (HDD), a solid state drive (SSD), a flexible disk (FD), a magneto-optical disc (MO disc), a compact disc (CD), a digital versatile disc (DVD), a secure digital card (SD card), or a universal serial bus memory (USB memory).

The storage 10d may be incorporated into a computer body constituting the image control apparatus 10, or may be externally attached to the computer body. Alternatively, the storage 10d may be composed of a network attached storage (NAS) or the like.

The storage 10d may be an external device that can communicate with one computer constituting the image control apparatus 10 through the network 1, such as, for example, the online storage 70 or a database server. The online storage 70 according to the present embodiment is a device that is a storage location of the captured image group 30a captured by the imaging apparatus 30 and that may function as a storage server which is accessed from the user terminal 60 through a uniform resource locator (URL) as a result of reading the access code 22a and responds with target image data.

The input device 10e is a device that receives an input operation performed by an operator of the image control apparatus 10, and is composed of, for example, a touch panel, a keyboard, or a microphone. The output device 10f is composed of, for example, a display or a speaker. The output device 10f may function as a device that outputs the captured image group 30a and the access code 22a to the user. In this case, the output device 10f is disposed in, for example, the service facility.

A program for an operating system (OS), an application program for executing image processing such as data management of the captured image group 30a and generation and transmission of display data, and a code generation application program for encoding information on the storage location of the captured image group 30a are installed on the computer constituting the image control apparatus 10 as software.

These programs are read out and executed by the processor 10a and appropriately cooperate with other hardware devices of the image control apparatus 10 to implement each function of the reception portion 21, the generation portion 22, the control portion 23, and the output portion 24 (see FIG. 3) in the computer constituting the image control apparatus 10. Some functions may be implemented using artificial intelligence (AI).

More specifically, each of the functional portions executes a series of processing such as acquisition and storage of the captured image group 30a obtained by imaging during the specific period via the imaging apparatus 30, and generation and output of the access code 22a related to the captured image group 30a. Hereinafter, details of each of the functional portions will be described.

### Reception Portion

The reception portion 21 receives input of information related to the specific imaging period in the imaging apparatus 30 disposed in the service facility, and input of the captured image group 30a captured by the imaging apparatus 30 in the service facility. The specific imaging period is a period in which an image of a customer using the imaging service in the service facility as a subject is captured. Hereinafter, the specific imaging period will be simply referred to as the “imaging period”. The information related to the imaging period in the imaging apparatus 30 is a start instruction and a finish instruction of the imaging using the imaging apparatus 30. A person who issues these instructions is not particularly limited and may be a customer who is the subject to be imaged, an employee of the service facility, or in a case where a professional cameraman is present, the cameraman.

In the present embodiment, a method of acquiring information on the imaging period and the captured image group 30a in the reception portion 21 is not particularly limited. Examples of the method of acquiring information on the imaging period (information for designating an imaging start and an imaging finish) in the imaging apparatus 30 include displaying, via the reception portion 21, a designation reception screen on the input device 10e and acquiring the information through a user operation on the designation reception screen. Other methods can be assumed to include a case of transmitting the designation reception screen to the user terminal 60 and acquiring the information through the designation reception screen. Examples of the method of acquiring the captured image group 30a can be assumed to include a case of receiving, via the reception portion 21, the captured image group 30a through an interface provided in the imaging apparatus 30 and a communication line.

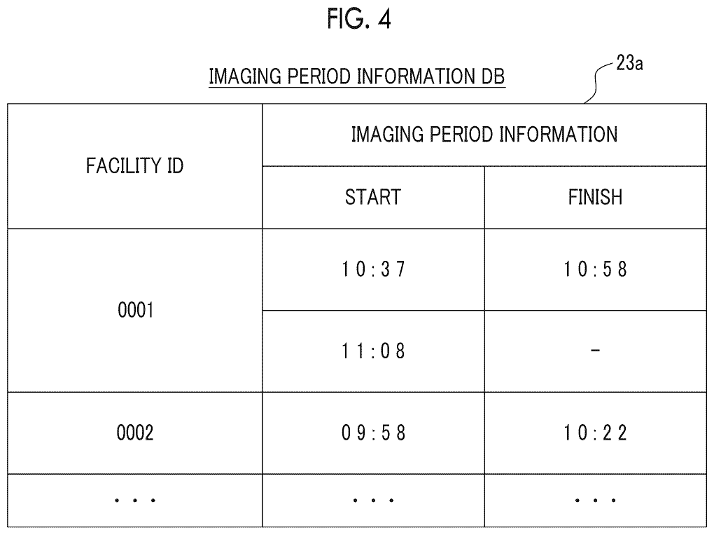

The reception portion 21 holds the acquired information on the imaging period (hereinafter, referred to as imaging period information 21a) in the memory 10b or the storage 10d, and notifies the control portion 23 of the information. The control portion 23 generates and manages an imaging period DB 23a by accumulating the imaging period information 21a in association with a facility (for example, an imaging room) that the user (a customer of the imaging service) enters in the service facility. A data structure of a record, that is, the imaging period information 21a, in the imaging period DB 23a is associated with information such as an ID of the facility in which imaging via the imaging apparatus 30 is performed, and an imaging start time point and an imaging finish time point, as shown in FIG. 4. The ID of the facility is information (identification number) held in advance in the input device 10e that receives the input operation of the user, and can be acquired from the input device 10e.

In a case where the imaging apparatus 30 is mounted on the image control apparatus 10, the reception portion 21 may acquire image data of the captured image group 30a captured by the imaging apparatus 30.

The image data of the captured image group 30a acquired by the reception portion 21 may be assumed to be image data in which, for example, a service customer who is the user, and the service user's companions and pet are subjects. In addition, image data in which various matters such as a landscape, a building, an astronomical phenomenon, and a meteorological phenomenon are subjects can also be assumed. The image data of the captured image group 30a may be used as a material image for various products such as a photo book, a yearbook, a photo album, and an image sticker of the user.

The image data captured by the imaging apparatus 30 and acquired by the reception portion 21 constitutes the captured image group 30a and includes a still image captured during the imaging period and a live view image that is a real-time captured image during imaging.

### Generation Portion

In the present embodiment, the access code 22a is generated by the generation portion 22 of the image control apparatus. The access code 22a is generated in conjunction with a control of the imaging finish in the control portion 23 described later. Accordingly, in a case where the generation portion 22 receives notification of the imaging finish from the control portion 23, the generation portion 22 executes generation of the access code 22a.

In generating the access code 22a, the generation portion 22 acquires address information, that is, a uniform resource locator (URL), of a region storing the captured image group 30a in the online storage 70 from the control portion 23, and generates the access code 22a by inputting the information into the code generation application program. A format of the access code 22a is not particularly limited and may be not only a one-dimensional or two-dimensional barcode but also a hyperlink or the like in which the URL is embedded.

### Control Portion

The control portion 23 in the present embodiment controls a start and a finish of imaging in the imaging apparatus 30 based on the information on the imaging period, that is, the imaging period information 21a indicating the imaging start and the imaging finish, received from the user by the reception portion 21. In this case, the imaging apparatus 30 has a remote imaging function. That is, the control portion 23 issues instructions to start and finish imaging of the imaging apparatus 30 through the remote imaging function. The remote imaging function is a function of receiving various instructions for imaging control from an external apparatus (in the present embodiment, the control portion 23 of the image control apparatus 10) through an appropriate communication network such as the network 1, and causing the imaging apparatus 30 to perform an imaging operation corresponding to the instructions.

Examples of a configuration for implementing the remote imaging function include a configuration comprising a communication chip corresponding to a communication protocol of the network 1, and a signal conversion chip that converts a signal received from the control portion 23 of the image control apparatus 10 by the communication chip into a control signal for the imaging apparatus 30 and transmits the control signal to a control unit of the imaging apparatus 30. For example, the signal received by the communication chip is generated by the control portion 23 in accordance with an imaging start or imaging finish instruction input through the input device 10e by the user.

In a case where the imaging apparatus 30 acquires information on the imaging start through the remote imaging function, the imaging apparatus 30, for example, starts imaging with a predetermined imaging angle of view or an imaging angle of view designated by the user. In conjunction with the imaging start, the imaging apparatus 30, for example, continuously executes imaging for each certain time period to obtain a plurality of captured images (that is, a captured image group). Image data of the plurality of captured images (captured image group) is stored and held in, for example, a memory of the imaging apparatus 30. Here, data of each image of the captured image group held in the memory is data of a still image.

The control portion 23 may recognize information related to the imaging finish (specifically, the imaging finish instruction) of the captured image group that was immediately previously captured, as the above information related to the imaging start (specifically, the imaging start instruction). Here, the captured image group that was immediately previously captured corresponds to a captured image group that is a target for outputting the immediately previous access code 22a. For the user who is currently a target for the service, the immediately previous access code 22a is an access code generated based on a captured image group that is captured with respect to a customer who used the same service facility immediately previously.

The above operation form of detecting the imaging start timing focuses on and appropriately addresses a possibility that the imaging finish timing of the user coincides with the imaging start timing of the subsequent user in the service facility. A situation where the imaging finish timing of the immediately previous user coincides with the imaging start timing of the subsequent user corresponds to a situation where customers of the imaging service visit the service facility one after another without a time gap.

In a case where the imaging apparatus 30 acquires information on the imaging finish through the remote imaging function, the imaging apparatus 30 finishes imaging, reads out the image data of the captured image group captured between the imaging start timing and the imaging finish timing from the memory, and transmits the image data to the image control apparatus 10. The control portion 23 of the image control apparatus 10 receives the image data of the captured image group 30a transmitted from the imaging apparatus 30, and stores the image data in a captured image DB 70a of the online storage 70. For example, the ID of the facility in which imaging is performed, an imaging date and time, and the captured image group 30a are associated with each other as a data structure in the captured image DB 70a. Each image included in the captured image group 30a is a still image.

In a case where imaging is finished and the image data of the captured image group 30a is stored in the captured image DB 70a of the online storage 70, the control portion 23 notifies the generation portion 22 of a URL corresponding to a storage region in which the image data is stored. As described above, the URL is used as data for generating the access code 22a.

### Output Portion

The output portion 24 outputs the access code 22a generated by the generation portion 22 to the user terminal 60 (display device) or the output device 10f of the image control apparatus 10. The customer of the imaging service who is the user executes a reading operation for the access code 22a via the user terminal 60 to access an address indicated by the access code 22a and view the captured image group 30a in the online storage 70.

In the present embodiment, the output portion 24 can output the access code 22a to the user terminal 60 by outputting display data for the access code 22a to the communication interface (transmission device) 10c that transmits display data to the user terminal 60.

The output portion 24 may transmit printing data of the access code 22a to a printing apparatus 50 through the network 1. In this case, processing of printing the access code 22a on a printing medium (for example, paper) is executed in the printing apparatus 50. The user can acquire the printing medium on which the access code 22a is printed, in the service facility and bring the printing medium to any location such as home. The user can execute a reading operation for the access code 22a on the printing medium via the user terminal 60 to access the address indicated by the access code 22a and view the captured image group 30a in the online storage 70.

The output portion 24 can output the live view image, which is the captured image currently being captured by the imaging apparatus 30, to the user terminal 60 (display device) or the output device 10f of the image control apparatus 10. In this case, the image control apparatus 10 and the imaging apparatus 30 continue maintaining a connected state through the network 1 even during imaging, and the captured image (live view image) in the imaging apparatus 30 is instantly transmitted to the user terminal 60 and the like in real time. The customer of the imaging service who is the user can see a display screen of the live view image, view, for example, the captured image in which the user is a subject, and check whether appearance, posture, and the like in the image are good or bad.

Furthermore, in the present embodiment, the output portion 24 can display at least one image of the captured image group on the user terminal 60 (display device) or the output device 10f of the image control apparatus 10. For example, in a case where all images included in the captured image group 30a are displayed on the user terminal 60 or the like, checking the captured image may be complicated for the user. Meanwhile, in the present embodiment, only a limited number of images included in the captured image group 30a are displayed on the user terminal 60 or the like. Thus, checking the captured image is smooth and less burdensome work for the user.

A method of determining an image as a target to be displayed by the output portion 24 and the number of displayed images in the captured image group 30a is not particularly limited. An example of the method can be assumed to be a method of extracting a predetermined number of images satisfying a predetermined condition in order of imaging. The “predetermined condition” can be assumed to be a condition that the sizes or the number of subjects in focus in the image are greater than or equal to a reference value, a condition that the subject in the image is positioned at a center of the image, or the like. An existing image recognition technology may be appropriately used for specifying the subject in the image.

### Example of Image Control Method According to Present Embodiment

Next, an image processing flow using the same apparatus will be described as an operation example of the image control apparatus 10 in the present embodiment. The image processing flow described below uses the image control method according to the embodiment of the present invention. That is, each step in the image processing flow described below corresponds to a constituent of the image control method according to the embodiment of the present invention.

The following flow is merely an example. Some steps in the flow may be deleted, a new step may be added to the flow, or an execution order of two steps in the flow may be changed without departing from the gist of the present invention.

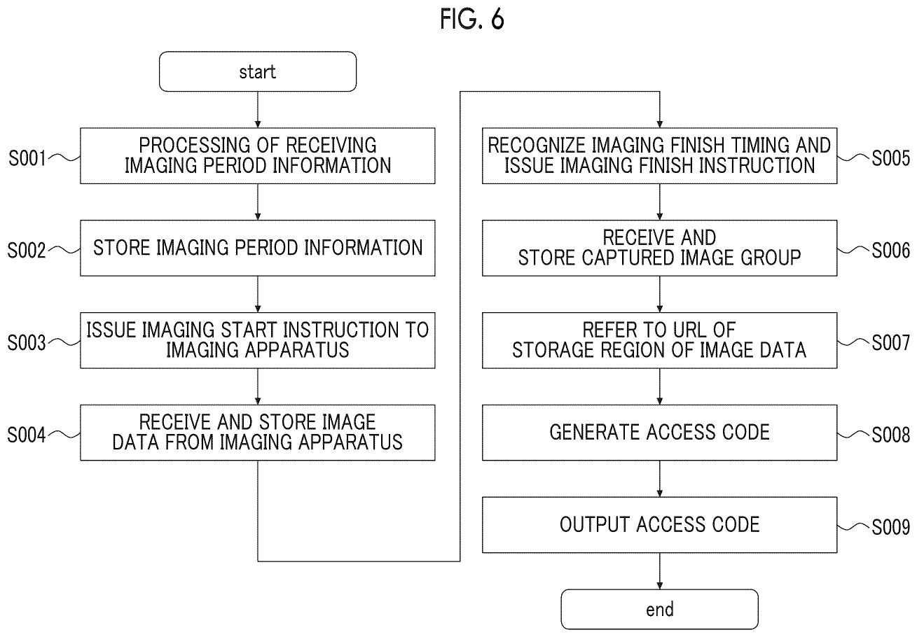

Each step in the image processing flow according to the present embodiment is executed in the order shown in FIG. 6 by the processor 10a comprised in the image control apparatus 10. That is, in each step in the image processing flow, the processor 10a executes processing corresponding to each step in FIG. 6 in data processing defined in the application program for image processing.

Specifically, in the image processing flow according to the present embodiment, first, the processor 10a executes processing of receiving input of the imaging period information 21a (S001). In this case, the processor 10a displays a reception screen for period designation on the input device 10e, and in a case where a user operation is performed through the designation reception screen, the processor 10a acquires the imaging period information 21a. While the imaging period information 21a can be assumed to include each of the imaging start instruction and the imaging finish instruction, the present invention is not limited to this, and a form of issuing only the imaging start instruction may also be assumed.

Next, the processor 10a stores the imaging period information 21a obtained in step S001 in the imaging period DB 23a in association with the facility ID (S002). The processor 10a requests the imaging apparatus 30 to start imaging based on the imaging start instruction indicated by the imaging period information 21a obtained in step S001 (S003).

An example of the imaging start instruction can also be assumed to be, for example, a form of using the information related to the imaging finish of the captured image group that was immediately previously captured, specifically, the imaging finish instruction. The imaging finish instruction of the captured image group that was immediately previously captured corresponds to information on the imaging finish related to the captured image group that is a target for outputting the immediately previous access code 22a, as described above.

In the imaging apparatus 30, imaging starts in a case where the imaging start instruction is received, and the image data obtained by the imaging is transmitted to the image control apparatus 10 through the network 1. The image data captured by the imaging apparatus 30 constitutes the captured image group 30a, and is data of a still image in which the customer of the service who is the user, the customer's companions, and the like are subjects. Image data of a still image is data of a still image when main imaging is performed by the service customer by operating the input device 10e (for example, when an imaging button provided on the display screen of the live view image is pushed).

The processor 10a receives the image data of the still image transmitted from the imaging apparatus 30, and stores the image data in the captured image DB 70a in the online storage 70 (S004). Each time the main imaging, that is, capturing of the still image, is performed during the imaging period, the imaging apparatus 30 transmits the image data of the still image. Each time the processor 10a receives the image data from the imaging apparatus 30, the processor 10a executes step S004. Accordingly, the number of images included in the captured image group 30a gradually increases.

During the imaging period, the image control apparatus 10 and the imaging apparatus 30 continue maintaining a state where both are connected through the network 1. While not particularly shown in FIG. 6, the processor 10a may receive the live view image, which is the captured image currently being captured by the imaging apparatus 30, from the imaging apparatus 30 during the imaging period. In this case, the processor 10a may display the received live view image on the output device 10f in real time. Alternatively, the processor 10a may display at least one image of the captured image group on the user terminal 60 (display device) or the output device 10f.

Next, in a case where the imaging finish timing indicated by the imaging period information 21a received in S001 is reached, or the processor 10a receives the imaging period information 21a including information on the imaging finish again, the processor 10a transmits an imaging finish request to the imaging apparatus 30 (S005). Meanwhile, in a case where the imaging apparatus 30 receives the imaging finish request, the imaging apparatus 30 finishes imaging that has continued so far, and transmits the image data of the captured image group captured between the imaging start timing and the imaging finish timing to the image control apparatus 10.

The processor 10a receives the image data of the captured image group 30a transmitted from the imaging apparatus 30, and stores the image data in the captured image DB 70a of the online storage 70 (S006). In a case where the captured image group 30a is stored in the captured image DB 70a in conjunction with the imaging finish, the processor 10a refers to the URL corresponding to the storage region in which the captured image group 30a is stored, in the online storage 70 (S007).

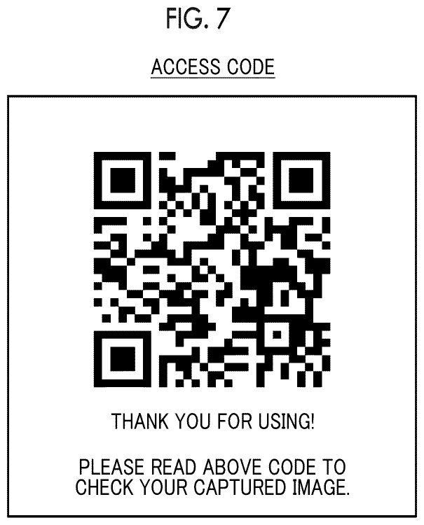

The processor 10a inputs information on the URL into the code generation application program to generate the access code 22a such as a two-dimensional barcode (S008). The processor 10a outputs the access code 22a generated in step S008 to the output device 10f (display device) or the user terminal 60 to display, for example, the access code 22a on a screen as shown in FIG. 7 (S009).

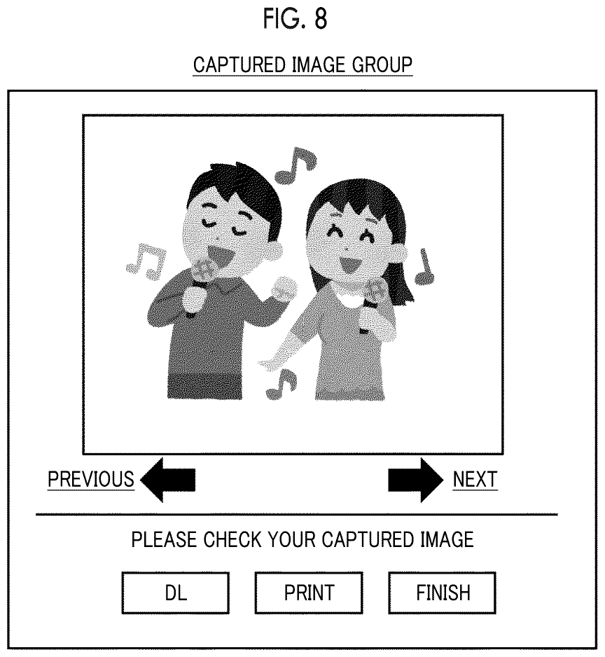

The user executes a reading operation using a camera unit, a reader, and the like of the user terminal 60 for the access code 22a displayed on the output device 10f or the like. The URL embedded in the access code 22a is read through the reading operation via the user terminal 60, and the captured image group 30a indicated by the URL in the online storage 70 can be accessed. Accordingly, the user can view the captured image group 30a on the user terminal 60 (see FIG. 8). In addition, the user can use the data in various manners such as downloading the image data, transmitting the downloaded image data to another apparatus, or printing the image indicated by the image data on photographic paper or the like.

The processor 10a may implement output of the access code 22a to the user terminal 60 by outputting the display data for the access code 22a to the communication interface (transmission device) 10c that transmits the display data to the user terminal 60.

The processor 10a may transmit the printing data of the access code 22a to the printing apparatus 50 through the network 1. In this case, processing of printing the access code 22a on a printing medium (for example, paper) is executed in the printing apparatus 50.

### Specific Scene for Applying Present Embodiment

Specific scenes for applying the above embodiment will be described with a plurality of examples (hereinafter, Examples 1 to 4).

### Example 1

Example 1 is a case where, for example, a self-imaging service is provided using a Ferris wheel installed in a theme park or the like as the service facility and using a gondola in which a passenger rides on the Ferris wheel as a facility for imaging. That is, Example 1 is an application of the present invention to an imaging service performed using a gondola of a Ferris wheel as a selfie studio. FIG. 1 shows a network configuration example in Example 1.

In Example 1, the user who is the service customer rides in the gondola of the Ferris wheel and performs self-imaging in the gondola while the gondola in which the user is riding travels one round in the Ferris wheel. More specifically, the user receives a control tablet when riding in the gondola. The control tablet corresponds to the image control apparatus 10 in Example 1. The imaging apparatus 30 having the remote imaging function is installed in the gondola. Specifically, the imaging apparatus 30 is installed at a predetermined position in the gondola. The imaging apparatus 30 and the control tablet are connected to each other in a communicable manner, and the control tablet can connect to the online storage 70 through the network 1 for wired or wireless communication.

The user issues the imaging start instruction by touching a predetermined button displayed on a touch panel (corresponding to the input device 10e) of the control tablet in the gondola. In a case where the control tablet receives the imaging start instruction, the control tablet transmits an imaging request to the imaging apparatus 30. In a case where the imaging apparatus 30 receives the imaging request, the imaging apparatus 30 starts imaging and transmits the live view image, which is the captured image currently being captured, to the control tablet. The user sees the live view image on a screen of the control tablet and issues an instruction to perform the main imaging by touching an imaging button displayed on the screen of the control tablet at a timing at which the user is in a state suitable for imaging. In a case where the control tablet receives the instruction to perform the main imaging, the control tablet transmits a request for the main imaging to the imaging apparatus 30. In a case where the imaging apparatus 30 receives the request for the main imaging, the imaging apparatus 30 captures a still image at the moment. The main imaging, that is, capturing of the still image, is repeated while the gondola in which the user is riding travels one round. Accordingly, a captured image group including a plurality of still images in which the user is a subject is acquired, and is stored and held in the memory of the imaging apparatus 30.

Then, the user issues the imaging finish instruction by touching a predetermined button displayed on the touch panel of the control tablet after the gondola in which the user is riding has traveled one round. In a case where the control tablet receives the imaging finish instruction, the control tablet transmits information on the imaging finish to the imaging apparatus 30. In conjunction with this, the imaging apparatus 30 transmits the captured image group held in the memory to the control tablet, and the control tablet receives and acquires the transmitted captured image group. In conjunction with transmission of the captured image group, the memory of the imaging apparatus 30 is cleared, and the captured image group is erased from the memory.

The control tablet uploads the image data of the captured image group transmitted from the imaging apparatus 30 to the captured image DB 70a of the online storage 70. The control tablet acquires information on the URL corresponding to the storage region of the captured image group in the online storage 70, and inputs the information into the code generation application program to generate the access code 22a.

The control tablet displays the generated access code 22a on the touch panel of the control tablet or a display (corresponding to the display device 40) comprised in the gondola. Here, the access code 22a may be output to the user terminal 60 carried by the user. Alternatively, data of the access code 22a may be transmitted to the printing apparatus 50 installed in an area around the Ferris wheel, and a receipt on which the access code 22a is printed may be output and provided to the user.

Then, the user reads the access code 22a displayed on the touch panel of the control tablet or the access code 22a printed on the receipt using the camera unit, the reader, and the like of the user terminal 60. By performing this reading operation, the user terminal 60 accesses the captured image group in the online storage 70 and performs display and the like of the captured image group on the display. The user can view each captured image constituting the captured image group, and download a desired image or print the image using a printing service or the like.

The service for downloading, printing, and the like of the image may be available on a condition that billing processing via predetermined settlement means is performed. The control tablet may have a function of recommending an image satisfying a specific condition in the captured image group as a target for the printing service. The specific condition is, for example, a condition that the sizes or the number of subjects in focus in the captured image are greater than or equal to a reference value, or a condition that the subject in the captured image is positioned at a center of the image.

The billing processing in conjunction with use of the service for downloading, printing, and the like of the image and recommendation of the captured image to be a target for the printing service can also be applied to Examples 2 to 4 below. These contents will not be described in Examples 2 to 4.

The above series of steps is repeated each time a new user rides in a gondola of the Ferris wheel and uses the self-imaging service in the gondola.

A person who issues the imaging start and imaging finish instructions on the control tablet is not limited to the user who is the service customer. For example, an employee of the Ferris wheel may issue the instructions.

### Example 2

Example 2 is a case where a concert venue or a live venue is used as the service facility, and a cameraman images the user who is a visitor, while moving in the venue and provides the captured image to the user.

Example 2 may be assumed to be not only the above case but also a case where an imaging booth installed in a concert venue or a live venue is used as the service facility, and a cameraman images the user in the imaging booth and provides the captured image.

In the above case, the user can ask the cameraman to capture an image in which the user is shown together with an artist performing at the concert or the live. The cameraman operates the imaging apparatus 30 and a control tablet connected to the imaging apparatus 30 in a communicable manner. The control tablet corresponds to the image control apparatus 10 in Example 2. The control tablet can connect to the online storage 70 through the network 1 of wireless communication.

The cameraman serves a plurality of users who use the imaging service, one at a time and, in starting imaging one user as a subject, issues the imaging start instruction by touching a predetermined button displayed on a touch panel (corresponding to the input device 10e) of the control tablet.

The imaging start instruction may be issued by the user. For example, in a case where the user who is waiting for his or her turn to use the imaging service reaches his or her turn to use the service, the user prepares an item that is distributed in advance and given to the user, including an IC chip, or the user terminal 60 on which the IC chip is mounted, and brings the item or the user terminal 60 close to the control tablet. Accordingly, information stored in the IC chip is read by a reader function of the control tablet, and the read information may be received as the imaging start instruction.

In a case where the control tablet receives the imaging start instruction, the control tablet transmits an imaging start request to the imaging apparatus 30. In a case where the imaging apparatus 30 receives the imaging start request, the imaging apparatus 30 starts imaging and captures the current live view image. The live view image is displayed on a finder of the imaging apparatus 30, and the cameraman pushes an imaging button (release button) of the imaging apparatus 30 at a suitable timing while seeing the live view image. Accordingly, the imaging apparatus 30 captures a still image when the imaging button is pushed. Capturing of the still image is repeated a plurality of times for one user. Accordingly, a captured image group including a plurality of still images in which the user is a subject is acquired, and is stored and saved in the memory of the imaging apparatus 30.

In a case where a predetermined number of still images are captured for one user, the cameraman issues the imaging finish instruction by touching a predetermined button displayed on the touch panel of the control tablet at the moment. In a case where the control tablet receives the imaging finish instruction, the control tablet transmits information on the imaging finish to the imaging apparatus 30. In conjunction with this, the imaging apparatus 30 transmits the captured image group held in the memory to the control tablet, and the control tablet receives and acquires the transmitted captured image group. In conjunction with transmission of the captured image group, the memory of the imaging apparatus 30 is cleared, and the captured image group is erased from the memory.

The control tablet uploads the image data of the captured image group transmitted from the imaging apparatus 30 to the captured image DB 70a of the online storage 70. The control tablet acquires information on the URL corresponding to the storage region of the captured image group in the online storage 70, and inputs the information into the code generation application program to generate the access code 22a.

The control tablet displays the generated access code 22a on the touch panel of the control tablet or a display (display device 40) installed in the venue. Here, the access code 22a may be output to the user terminal 60 carried by the user. Alternatively, data of the access code 22a may be transmitted to the printing apparatus 50 of a mobile type carried by the cameraman, and a receipt on which the access code 22a is printed may be output and provided to the user.

Then, the user reads the access code 22a displayed on the touch panel of the control tablet or the access code 22a printed on the receipt using the camera unit, a reader function, and the like of the user terminal 60. By performing this reading operation, the user terminal 60 accesses the captured image group in the online storage 70 and performs display and the like of the captured image group on the display. The user can view each captured image constituting the captured image group, and download a desired image or print the image using a printing service or the like.

The above series of steps is repeated each time a new user uses the imaging service (in other words, each time the user who reaches his or her turn to use the imaging service changes).

In Example 2, the imaging apparatus 30 having the remote imaging function may be installed at a predetermined location in the venue, and the cameraman may operate the control tablet to image the user via the imaging apparatus 30 through the remote imaging function.

The imaging start and imaging finish instructions issued by operating the control tablet are not limited to the instructions issued by the cameraman alone and may be issued by a plurality of staff members including the cameraman.

### Example 3

Example 3 is a case where a theme park is used as the service facility, and in an attraction that can be enjoyed by riding on a vehicle (for example, a roller coaster; hereinafter, an attraction A), the user who is a passenger is imaged a plurality of times while the vehicle travels, and the captured image is provided to the user.

In the attraction A, a plurality of imaging points are set in the middle of a traveling path of the vehicle, and the imaging apparatus 30 having the remote imaging function, specifically, a fixed-point camera, is installed around each imaging point. In a case where the vehicle passes through each imaging point, imaging via the imaging apparatus 30 positioned around the imaging point is automatically performed.

In the theme park, a control computer connected to the imaging apparatus 30 in a communicable manner is installed in an area assigned for the attraction A. The control computer corresponds to the image control apparatus 10 in Example 3. The control computer can connect to the online storage 70 through the network 1 of wired or wireless communication.

In Example 3, the user who enters the attraction A wears a wearable including an IC chip. Information read out from the IC chip includes a unique number (hereinafter, referred to as an admission number) assigned to the user. The wearable is assumed to be, for example, a wristband. In the following description, a case where the user wears a wristband as the wearable will be assumed.

At a time of admission to the theme park, the user installs an application software dedicated to the theme park (hereinafter, a dedicated app) on his or her user terminal 60, and a wristband is lent to the user. An employee of the theme park uses a reader to read an identification screen (for example, a two-dimensional barcode) that is displayed in a case where the user terminal 60 starts the dedicated app, and reads information such as the admission number and the like from the IC chip of the wristband lent to the user. The reader transmits a set of an identification number of the dedicated app read from an identification image and the admission number read from the wristband to the control computer. The identification number of the dedicated app is information specific to the user terminal 60 on which the dedicated app is installed.

The control computer holds the identification number of the dedicated app and the admission number of the wristband in association with each other in its storage means (the memory 10b or the storage 10d). On the control computer side, the admission number of the user and an identification ID of the user terminal 60 are registered in association with each other. Accordingly, in a case where the user scans his or her wristband with a reader unit near a seat on which the user sits in the vehicle of the attraction A, the control computer can specify a correspondence relationship among the admission number of the user, the identification number of the user terminal 60, and the vehicle and the seat on which the user rides. Therefore, in a case where the access code 22a is generated, the user terminal 60 that is a location to which the access code 22a is transmitted is determined.

Instead of reading the identification image of the dedicated app, the above reader may read identification information of the user terminal 60 from an IC chip incorporated in the user terminal 60.

In a case where the user rides on the vehicle in the attraction A, the user receives announcement through a display or a speaker mounted on the vehicle, and is prompted to bring his or her wristband into contact with the reader unit near the seat. In a case where the user scans the wristband with the reader unit in accordance with the announcement, the reader unit reads information such as the admission number from the IC chip of the wristband. In Example 3, the user's operation of reading the admission number from the IC chip of the wristband via the reader unit in the above manner corresponds to the imaging start instruction.

Then, the reader unit transmits the admission number read from the IC chip to the control computer together with a vehicle number and a seat number as information for specifying the vehicle and the seat on which the unit is installed. The control computer receives the imaging start instruction by acquiring the admission number.

In a case where the control computer receives the imaging start instruction, the control computer transmits an imaging request to the imaging apparatus 30 installed at a location around each imaging point. In this case, the control computer stores a location and the like of each imaging point in advance, and based on this information, can accurately specify (predict) when and which imaging point the vehicle of the attraction A passes through after departure. That is, the control computer can specify a timing at which the vehicle passes through each imaging point, and immediately before the vehicle passes through each imaging point, transmits an imaging request to the imaging apparatus 30 installed near the imaging point.

The imaging apparatus 30 that receives the imaging request executes imaging after a predetermined time elapses from reception of the imaging request. Accordingly, a still image including the vehicle passing through the imaging point and the user who is a passenger is captured by the imaging apparatus 30. Image data of the captured still image is transmitted from the imaging apparatus 30 to the control computer.

The control computer may transmit the imaging request to the imaging apparatus 30 in accordance with an elapsed time from departure of the vehicle, or may transmit the imaging request at a timing at which the vehicle passing through a predetermined position on the traveling path is detected by a sensor or the like.

The imaging request may include information on an imaging condition (for example, a shutter speed and an exposure condition). In this case, the imaging apparatus 30 that receives the imaging request captures a still image in accordance with the imaging condition included in the imaging request. The imaging condition may be set for each imaging apparatus 30. In this case, the imaging condition suitable for each imaging point can be set, and imaging via each imaging apparatus 30 can be executed under a suitable condition.

The above series of operations is repeated each time the vehicle travels along the traveling path and passes through each imaging point. Accordingly, imaging is executed the same number of times as the number of imaging points while the attraction A operates once, and the control computer acquires a plurality of captured image groups including the still images captured at each imaging point.

In a case where the vehicle passes through a last imaging point on the traveling path, the control computer receives the image data of the captured image from the imaging apparatus 30 installed near the last imaging point. By receiving this image data, the control computer receives the imaging finish instruction.

The control computer stores the image data of the captured image group including the still images captured at all of the plurality of imaging points in the online storage 70, and acquires information on the URL corresponding to the storage region. The control computer inputs the acquired information on the URL into the code generation application program to generate the access code 22a.

The control computer displays the generated access code 22a on, for example, a display (display device 40) installed near an exit of the attraction A. Alternatively, the access code 22a may be transmitted to the printing apparatus 50 installed near the exit of the attraction A, and a receipt on which the access code 22a is printed may be output and provided to the user.

The user registers the admission number stored in the IC chip of the wristband together with the identification ID of the user terminal 60 before experiencing the attraction A, and the control computer stores the admission number and the identification ID of the user terminal 60 in association with each other. In riding on the vehicle in the attraction A, the admission number is read from the IC chip of the wristband by the reader unit, and the control computer acquires the admission number read by the reader unit together with identification numbers of each of the vehicle and the seat on which the reader unit is mounted. Accordingly, the control computer can specify the user shown in each captured image and the user terminal 60 carried by the user. Based on this point, the control computer may specify the user shown in each image of the captured image group that can be viewed using the access code 22a, and may provide push notification of the access code 22a to the user terminal 60 carried by the user. For example, this push notification may be provided to the user terminal 60 on which the above dedicated app is installed as a target.

### Example 4

Example 4 is, for example, a case where a store-type selfie studio is used as the service facility, its imaging room is used as the facility for imaging, imaging is executed in response to entrance of a visitor (hereinafter, the user) to the imaging room, and the captured image is provided.

In Example 4, the user visits the selfie studio and scans a two-dimensional barcode in which a reservation number issued when making a reservation in advance or when visiting is encoded, with a reader unit in the imaging room that is a target for entrance. Accordingly, the imaging start instruction is issued.

For example, the user scans the two-dimensional barcode with the reader unit in the same manner as described above, when leaving or when a predetermined time of use elapses. Accordingly, the imaging finish instruction is issued.

The user can enjoy imaging in the imaging room from issuing of the imaging start instruction to issuing of the imaging finish instruction.

The selfie studio comprises a control computer that manages each imaging room. The control computer corresponds to the image control apparatus 10 in Example 4. Each imaging room in the studio comprises the imaging apparatus 30 having the remote imaging function, and an indoor reader unit. The control computer can connect to the reader unit, the reader unit in each imaging room, and the online storage 70 through the network 1 of wired or wireless communication.

The user registers a specific date and time when the user wants to perform imaging, as reservation information in a reservation system or the like operated by the selfie studio, and the above two-dimensional barcode is issued to the user in accordance with the registration. While the two-dimensional barcode is mainly assumed to be issued in a form of transmitting the two-dimensional barcode to the user terminal 60 used in a reservation operation by the user, a form of transmitting the two-dimensional barcode as printing data, and printing or outputting the printing data on a receipt or the like via a predetermined printing apparatus may also be assumed.

The user to which the above two-dimensional barcode is issued visits the selfie studio at a reservation time point, and scans the two-dimensional barcode displayed on the user terminal 60 with the reader unit installed at a storefront. The control computer acquires information on the reservation date and time as a result of reading the two-dimensional barcode through the reader unit, and collates the acquired information with a current situation of use in each imaging room. The situation of use in each imaging room is information indicating whether imaging is being performed in the imaging room. An imaging room for which information on the imaging finish is not received yet after receiving information on the imaging start from its reader unit can be determined as “in use”.

In a case where there is an imaging room not “in use”, that is, vacant, among each of the imaging rooms, the control computer outputs guidance information for the imaging room to the output device 10f such as a speaker or a display, and guides the user. Meanwhile, in a case where none of the imaging rooms are vacant, the control computer outputs information indicating that there is currently no vacancy to the output device 10f such as a speaker or a display, to prompt the user to wait for entrance. Here, it is suitable to notify the user with information on an estimated waiting time.

In a case where the user who uses the imaging room scans the above two-dimensional barcode with the reader unit in the imaging room, the control computer recognizes that the “imaging finish” instruction is issued. In this case, the control computer recognizes the imaging room as being in a vacant state, outputs the guidance information for the imaging room to the output device 10f such as a speaker or a display, for the user waiting for entrance, and guides the user.

The user who enters the imaging room in a vacant state scans the above two-dimensional barcode with the reader unit in the imaging room. This action corresponds to the imaging start instruction in the imaging room. In a case where the control computer receives a result of reading the above two-dimensional barcode from the reader unit, the control computer transmits the imaging start instruction to the imaging apparatus 30 comprised in the imaging room. Then, the user who enters can enjoy selfies (self-imaging) while using costumes, accessories, props, and the like prepared in the imaging room.

Meanwhile, the imaging apparatus 30 in the imaging room continuously executes imaging for each certain time period to obtain a captured image group in conjunction with the imaging start. Image data of the captured image group is stored and held in the memory of the imaging apparatus 30. Meanwhile, the image control apparatus 10 monitors whether imaging in the imaging room progresses and the predetermined time of use elapses, or capturing of a predetermined number of images is finished. This monitoring is executed by the control computer by specifying an elapsed time from the imaging start timing in each imaging room or acquiring a count value of the number of captured images in the imaging apparatus 30 for each certain time period.

As a result of the above monitoring, in a case where the predetermined time of use elapses or capturing of the predetermined number of images is finished, the control computer outputs announcement information from the display or the speaker in the imaging room to scan the two-dimensional barcode with the reader unit. In a case where the user scans the user's two-dimensional barcode with the reader unit in response to the announcement, the control computer recognizes that the imaging finish instruction has been issued, and notifies the imaging apparatus 30 of the imaging finish.

In a situation where there is no other user who is waiting, and another imaging room is vacant, the control computer can also operate to issue announcement indicating that an imaging time can be extended, and continue imaging in a case where the user is willing to give consent to payment of an additional fee.

The imaging apparatus 30 receives information on the imaging finish transmitted from the control computer, and finishes imaging. In conjunction with the imaging finish, the imaging apparatus 30 transmits the image data of the captured image group stored and held in the memory to the online storage 70. The control computer acquires information on the URL corresponding to the storage region of the captured image group in the online storage 70, and inputs the information into the code generation application program to generate the access code 22a. The control computer outputs the generated access code 22a to at least one of the display (output device 10f) comprised in the imaging room or the user terminal 60. Alternatively, the control computer may transmit data of the access code 22a to the printing apparatus 50 installed in the imaging room or at the storefront of the selfie studio, and output a receipt on which the access code 22a is printed to the user.

Users who use the selfie studio do not include only people who want to acquire and view a captured image as digital data, and include many people who want to print out the captured image on paper at the storefront and take the printed image. Considering this point, a printer that supports printing out of the captured image may be comprised in the selfie studio. In this case, the control computer also outputs, for example, announcement information for the user who wants to print out the captured image, in outputting the above announcement information (outputting announcement information corresponding to an elapse of the predetermined time or a situation where capturing of the predetermined number of images is finished). This announcement information is information for guidance, such as a location of the printer comprised in the selfie studio, and a path to the printer.

The user goes to the installation location of the printer and scans the access code 22a with the reader unit installed at the location. The image control apparatus 10 receives a result of reading the access code 22a via a reader unit, acquires the image data of the captured image group from the online storage 70, and displays the image data on the display (output device 10f) installed near a printer 55. In this display, the control computer, as shown in FIG. 8, generates and displays a screen on which a “print” button, a “download” button, and the like are disposed for images or image groups being displayed. The user can easily output a desired image to a medium such as paper through this screen operation.

Use of the imaging room in the selfie studio and printing out and downloading of the captured image are paid services, and a usage fee needs to be settled. Any settlement means may be adopted. For example, in a case where an operation of causing the user to register a credit card when making a reservation is adopted, the control computer may debit the fee by performing settlement processing of the credit card when use of the imaging room by the user is finished (imaging finish) or printing out is completed, or later. In this case, the control computer comprises an application program for executing the settlement processing with a financial institution such as a credit card company, or a settlement agent company, and holds authentication data such as an electronic certificate provided in advance from the financial institution or the settlement agent company.

In a case where the user does not register any information for settlement of the credit card or the like, the image control apparatus 10, for example, generates a two-dimensional barcode for payment in which payment information such as an amount of money to be paid and a payment due date is encoded, and outputs the two-dimensional barcode via the printing apparatus 50.

The user scans the two-dimensional barcode for payment output by the printing apparatus 50 with a dedicated payment machine operated by a partner financial institution, a convenience store, or the like of a selfie studio to perform payment processing on the dedicated payment machine.

In providing the imaging service in the selfie studio described above, the control computer can also support improvement in store operation. In this case, the image control apparatus 10 outputs support information such as service improvement, suggestion of contents of use for the user, and suggestion of the facility and equipment based on reservation contents managed by the reservation system and on a record of use of the user who actually uses the imaging room.

Thus, the control computer extracts and manages the reservation contents (for example, an age, a sex, an address, and a reservation course) and an attribute of the user indicated by the reservation contents for each selfie studio from a database or the like of the reservation system. The control computer manages the record of use (for example, a grade of the used imaging room, a time of use, and an output method of the captured image) for each selfie studio based on each information including identification information of the imaging room, the imaging start/finish time point, and downloading/printing out of the captured image, which can be specified by reading the two-dimensional barcode.

Therefore, the control computer analyzes a correspondence relationship between the user attribute, that is, a customer base, and the record of use by multiple regression analysis or machine learning. For example, the control computer specifies a degree of correlation between an item of the user attribute and an item of the record of use, and holds this information. Processing of such analysis and the like is executed for each selfie studio or each imaging room. The control computer, for example, specifies a service that is likely to be preferred for each customer base in the selfie studio based on the information on the degree of correlation for each certain time period or in response to a request from the selfie studio, and outputs this information to a terminal or the like in the selfie studio.

A trained model that specifies the degree of correlation by machine learning to minimize error by taking the user attribute as input and outputting the record of use may be created. In this case, a service suitable for a new user can be output by inputting an attribute of the new user into the trained model.

As a result of the above analysis, for example, a result indicating that a tendency of using a reservation course with a high fee and paying a high fee increases in proportion to a magnitude of the age of the user is obtained. In this case, as an operation setting in the reservation system of the selfie studio, the control computer outputs, to the terminal or the like in the selfie studio, suggestion information of contents such as recommendation of a reservation course that is popular for a customer base of the age, in accordance with the age received from the user when a reservation is received. In a case where a reservation is received through the reservation system in which such an operation setting is applied, user satisfaction can be expected to improve.

As a result of the above analysis, a degree of correlation between the user attribute and the costumes (including the accessories and the props) that are likely to be used in the imaging room is determined. In this case, the control computer outputs, to the terminal or the like in the selfie studio, information on the costumes and the like to be prepared for a main customer base (specified based on information obtained from the reservation system) in the selfie studio for which a support request is made. In the selfie studio in which the costumes and the like are prepared based on this information, user satisfaction can be expected to improve.

### Other Embodiments

While a specific embodiment of the present invention is described above, the above embodiment is merely an example for easy understanding of the present invention, and does not limit the present invention. That is, changes or improvements may be made to the embodiment described below without departing from the gist of the present invention. In addition, the present invention includes its equivalents. Furthermore, the embodiment of the present invention may include a form of combination of the above embodiment and one or more of the following modification examples.

### Computer Constituting Image Control Apparatus

In the above embodiment, the image control apparatus according to the embodiment of the present invention is composed of a computer that is directly used by the user, such as a terminal (client terminal) owned by the user. However, the present invention is not limited to this. The image control apparatus according to the embodiment of the present invention may be composed of, for example, a computer that can be indirectly used by the user, such as a server computer. The server computer may be, for example, a server computer for a cloud service, specifically, a server computer for an application service provider (ASP), software as a service (SaaS), platform as a service (PaaS), or infrastructure as a service (IaaS). In this case, in a case where necessary information is input into a client terminal, the server computer performs various types of processing (operation) based on the input information, and an operation result is output to the client terminal side. That is, a function of the server computer constituting the image control apparatus according to the embodiment of the present invention can be used on the client terminal side.

### Configuration of Processor

In the present embodiment, each type of processing is executed by any computer. Any computer may execute such processing via a processor, a program, or a combination thereof. Any computer may be a general-purpose computer, a computer for a specific purpose, a system such as a workstation, or other hardware elements capable of executing a program.

The processor may be composed of one or a plurality of pieces of hardware, and types of the hardware are not limited. For example, the processor may be composed of hardware such as a central processing unit (CPU), a micro processing unit (MPU), a programmable logic device such as a field programmable gate array (FPGA), a dedicated circuit for executing a specific type of processing, such as an application specific integrated circuit (ASIC), a graphic processing unit (GPU), or a neural processing unit (NPU). The processor includes each unit or each means for executing various types of processing in the present embodiment. Types of the hardware may be a combination of different types of the hardware. In a case where a plurality of pieces of hardware are configured to execute one or a plurality of types of processing of a processor, the plurality of pieces of hardware may be present in apparatuses physically separated from each other, or may be present in the same apparatus. In any embodiment, an order of each type of processing performed by the processor is not limited to the above order and may be appropriately changed. The hardware is composed of an electric circuit (circuitry) in which circuit elements such as semiconductor elements are combined.

The present embodiment may be implemented by hardware, software, firmware, microcode, or a combination thereof. Software, firmware, and microcode are composed of a program. For example, the program may be a program module group, and each function thereof may be implemented by a processor configured to execute each function. The program may be a program code or a plurality of code segments saved in one or a plurality of non-transitory computer-readable media (for example, storage media or other storages). The program may be divided and saved in a plurality of non-transitory computer-readable media present in apparatuses physically separated from each other. The program code or the code segments may represent any combination of a procedure, a function, a subprogram, a routine, a subroutine, a module, a software package, a class, an instruction, a data structure, and a program statement. The program code or the code segments may be connected to other code segments or hardware circuits by transmitting and receiving information, data, an argument, a parameter, or contents of a memory.

### EXPLANATION OF REFERENCES

1: network
10: image control apparatus
10a: processor
10b: memory
10c: communication interface
10d: storage
10e: input device
10f: output device
21: reception portion
21a: imaging period information
22: generation portion
22a: access code
23: control portion
23a: imaging period DB
24: output portion
30: imaging apparatus
30a: captured image group
40: display device
50: printing apparatus
60: user terminal
70: online storage
70a: captured image DB

What is claimed is:

1. An image control apparatus comprising:
a processor,
wherein the processor is configured to:
acquire information related to a specific imaging period in an imaging apparatus;
output a captured image group captured in the specific imaging period by the imaging apparatus to a storage device; and
in a case where the specific imaging period is finished, output access information for accessing the captured image group in the storage device to a display device.

2. The image control apparatus according to claim 1,
wherein each image of the captured image group is a still image.

3. The image control apparatus according to claim 1,
wherein the information related to the specific imaging period is an imaging start instruction and an imaging finish instruction in the imaging apparatus.

4. The image control apparatus according to claim 3,
wherein the imaging apparatus has a remote imaging function, and
the processor is configured to, based on the received imaging start instruction and the received imaging finish instruction, control a start and a finish of imaging of the imaging apparatus through the remote imaging function.

5. The image control apparatus according to claim 1,
wherein the processor is configured to:
receive a captured image being captured by the imaging apparatus from the imaging apparatus; and
output each image of the received captured image group to the display device.

6. The image control apparatus according to claim 5,
wherein the processor is configured to:
receive a live view image that is the captured image being captured by the imaging apparatus, from the imaging apparatus; and
display the received live view image on the display device in real time.

7. The image control apparatus according to claim 1,
wherein the processor is configured to display at least one image of the captured image group on the display device.

8. The image control apparatus according to claim 3,
wherein the processor is configured to recognize, as the imaging start instruction, the imaging finish instruction related to a captured image group that is a target for outputting immediately previous access information.

9. The image control apparatus according to claim 3,
wherein the imaging apparatus has a remote imaging function, and
the processor is configured to:
receive the imaging start instruction and the imaging finish instruction through an operation reception apparatus for receiving the imaging start instruction and the imaging finish instruction; and
based on the start instruction and the finish instruction, control a start and a finish of imaging of the imaging apparatus through the remote imaging function.

10. The image control apparatus according to claim 1,
wherein the processor is configured to:
generate an access code that is the access information, by encoding information related to a storage location of the captured image group in the storage device; and
output display data for the access code to a transmission device that transmits the display data to a terminal of a user.

11. The image control apparatus according to claim 1,
wherein the processor is configured to:
generate an access code that is the access information, by encoding information related to a storage location of the captured image group in the storage device; and
transmit printing data of the access code to a printing apparatus.

12. An image control method comprising:
a step of acquiring, via a processor, information related to a specific imaging period in an imaging apparatus;
a step of outputting, via the processor, a captured image group captured in the specific imaging period by the imaging apparatus to a storage device; and
a step of outputting, via the processor, in a case where the specific imaging period is finished, access information for accessing the captured image group in the storage device to a display device.

13. A non-transitory computer-readable recording medium storing a program for causing a computer to execute each step included in the image control method according to claim 12.
